(19) United States
(12) Patent Application Publication
(10) Pub. No.: US 2016/0145083 A1
(43) Pub. Date: May 26, 2016

(54) Lifting Arrangement

(71) Applicant: CHRISMAN JOËL LOUW, Stil Bay (ZA)

(72) Inventor: CHRISMAN JOËL LOUW, Stil Bay (ZA)

(21) Appl. No.: 14/947,668

(22) Filed: Nov. 20, 2015

(30) Foreign Application Priority Data
Nov. 21, 2014 (ZA) 2014/08557

(51) Int. Cl. B66D 3/14

(52) U.S. Cl. CPC B66D 3/14

(57) ABSTRACT

The invention discloses a lifting arrangement, which includes a base supporting structure adapted to be placed firmly on supporting ground; and a ratchet system adapted to be supported by the base supporting structure, and being adapted to assist in lifting a motorcycle and/or quad-bike. The motorcycle and/or quad-bike is adapted to be lifted to enable repairs to be done to the motorcycle and/or quad-bike. The ratchet is operated by means of downward pressure and/or force.

### FIELD OF INVENTION

The present invention relates to a lifting arrangement.

More particularly, the present invention relates to a lifting arrangement for lifting objects such as fallen motorcycles and quad-bikes or for lifting the motorcycles and quad-bikes for repairs.

### BACKGROUND TO INVENTION

Motorcycles and quad-bikes are extremely popular transport means and have developed into a culture and way of life for many. One problem with many motorcycles is their weight running into hundreds of kilograms.

Unfortunately the average person battles to lift a heavy motorcycle once it has fallen down or to lift it to attend to repairs. Even if they manage to lift the motorcycle there is the danger of straining one's back or causing other bodily injuries.

It is an object of the invention to suggest a lifting arrangement in overcoming the aforementioned problems.

### SUMMARY OF INVENTION

According to the invention, a lifting arrangement includes:
(a) a base supporting structure adapted to be placed firmly on supporting ground; and
(b) a ratchet system adapted to be supported by the base supporting structure, and being adapted to assist in lifting a motorcycle and/or quad-bike.

The motorcycle and/or quad-bike may be lifted to enable repairs to be done to the motorcycle and/or quad-bike.

The base supporting structure may include at least two legs portion for stability

The legs portions may each include base plates or foot pieces.

The arrangement may include centre-piece adapted to be telescopically connected to the base supporting structure and/or the ratchet system.

The ratchet may be operated by means of downward pressure and/or force.

### BRIEF DESCRIPTION OF DRAWINGS

The invention will now be described by way of example with reference to the accompanying schematic drawings.

In the drawings there is shown in:

FIG. 1: a plan view of the lifting arrangement according to the invention;

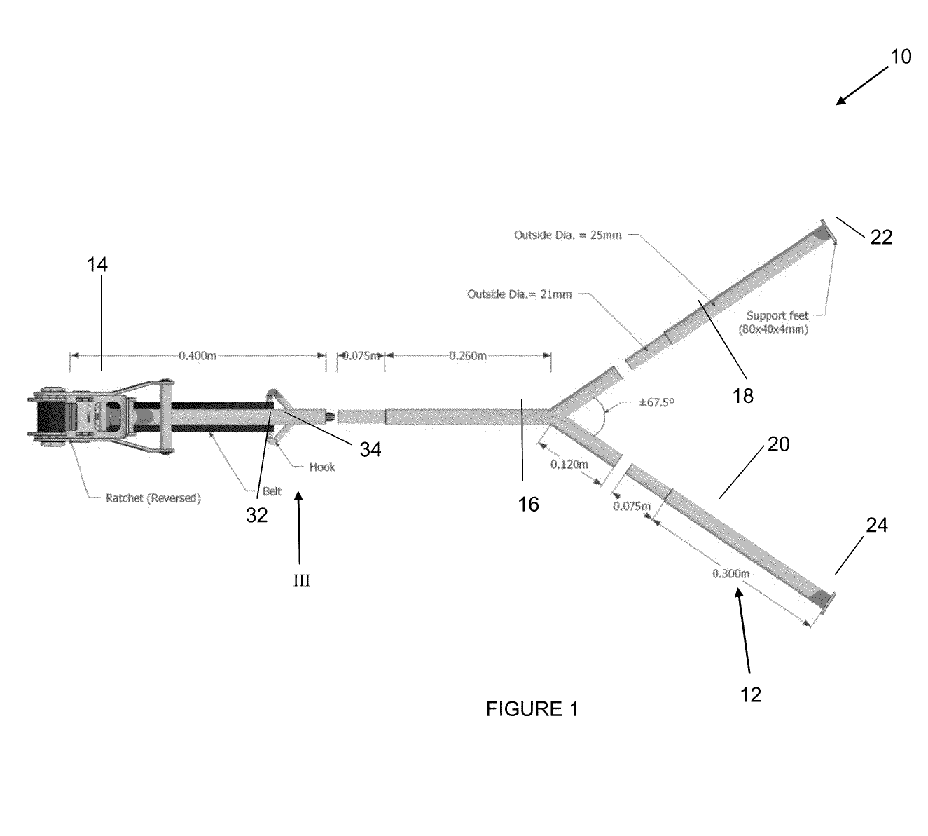

FIG. 2: a detailed view of the ratchet of the lifting arrangement according to the invention;

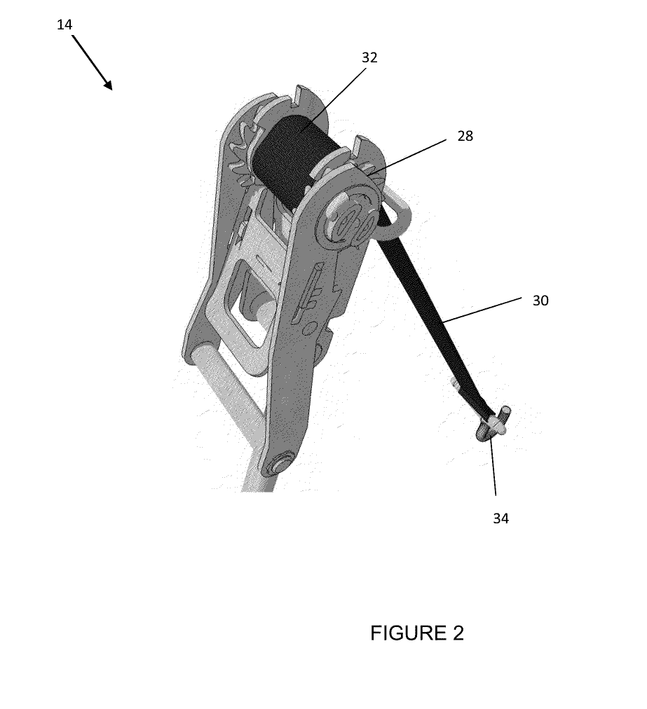

FIG. 3: a side view of the lifting arrangement as seen from arrow III in FIG. 1;

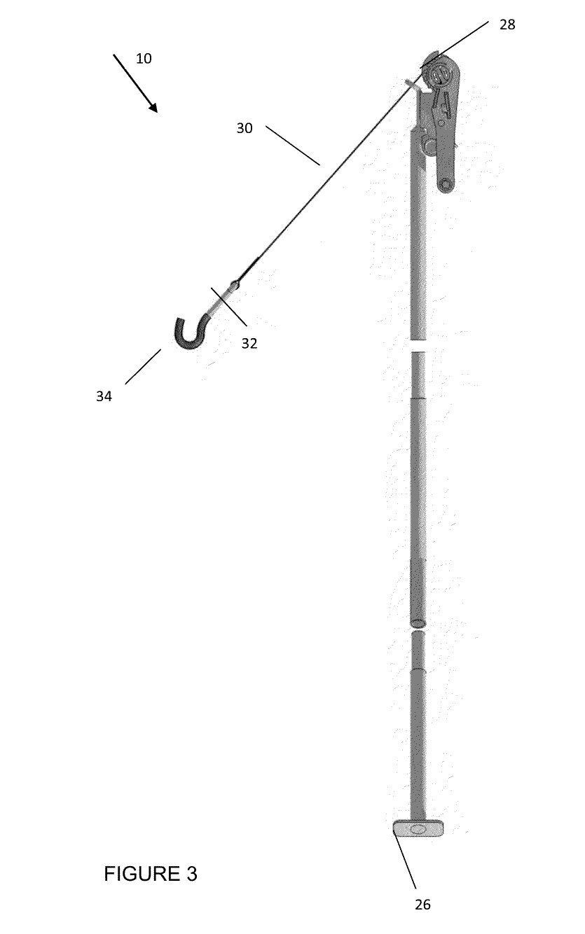

FIG. 4: a perspective view of the base supporting means including two leg portions of the lifting arrangement shown in FIG. 1;

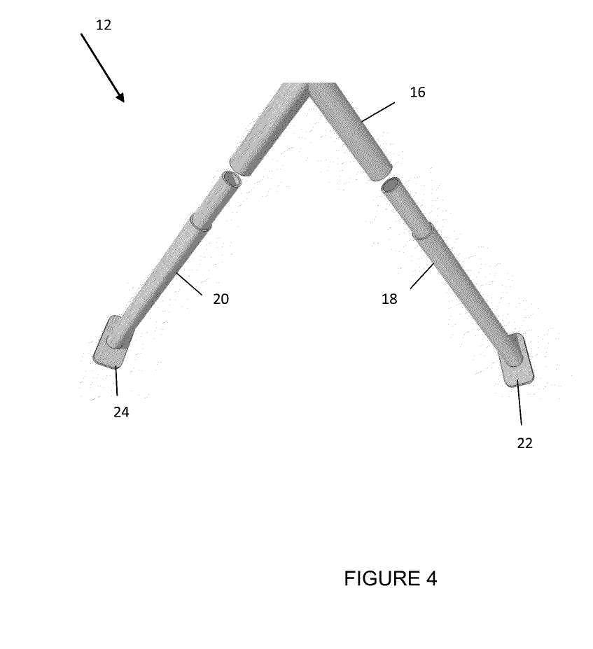

FIG. 5: a perspective view of the ratchet of the lifting arrangement as seen in FIG. 1; and

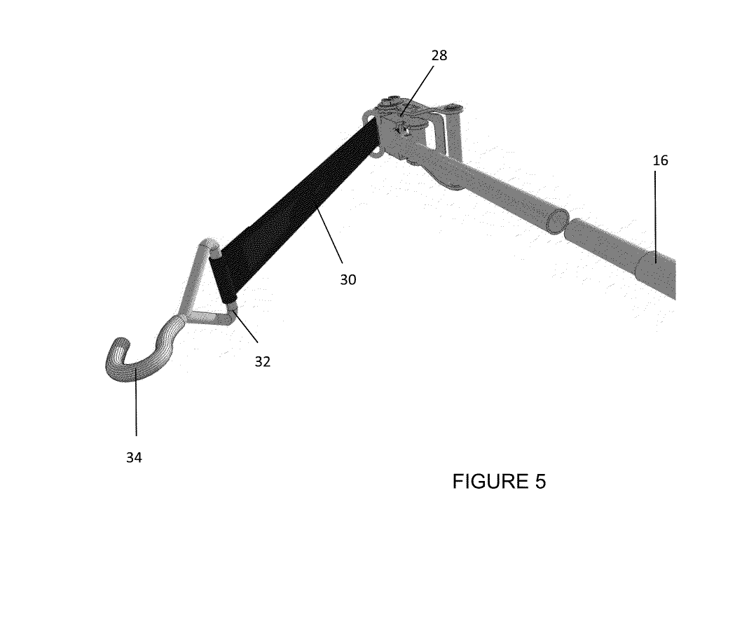

FIG. 6: a perspective view of the lifting arrangement according to the invention illustrating how a motorcycle is lifted.

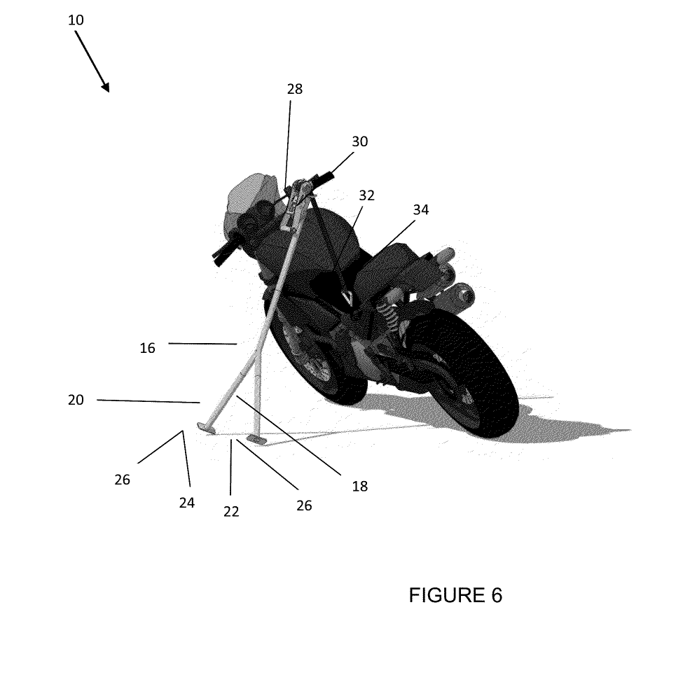

### DETAILED DESCRIPTION OF DRAWINGS

Referring to the drawings, a lifting arrangement, generally indicated by reference numeral 10, in accordance to the invention is shown.

The lifting arrangement 10 according to the invention includes
(a) a base supporting structure 12 adapted to be placed firmly on the ground;
(b) a ratchet system 14 adapted to be supported by the base supporting structure 12, and being adapted to assist in lifting a motorcycle and/or quad-bike.

The arrangement 10 includes a centre-piece 16 adapted to be telescopically connected to the base supporting structure 12 and the ratchet system 14.

The motorcycle and/or quad-bike may be in a fallen over position.

The motorcycle and/or quad-bike may be lifted to enable repairs to be done to the motorcycle and/or quad-bike.

The base supporting structure 12 includes two leg portions 18 and 20 for stability. The leg portions 18 and 20 each include base plates or foot pieces 22 and 24 and a drain hole 26 for the electroplating process. The base plates or foot pieces 22 and 24 consist of a 40 mm×5 mm flat-iron, 85 mm long, with a 5 mm diameter drain hole 26 in the bottom. The leg portions 18 and 20 consist of 25 mm×2 mm diameter stems being 300 mm long. The base supporting structure 12 includes a 21.4 mm diameter pipe 10 being press fit, 150 mm long, 75 mm deep and being adapted to act as a telescopic extension between the leg portions 18 and 20 and the diameter pipes of the centre-piece 16.

The centre piece 16 consists of a 25 mm×2 mm diameter round tube stem being 255 mm long and having two 25 mm×2 mm diameter pipes being 130 mm long and adapted to join the round tube stem to the leg portions 18 and 20 of the base supporting structure 12 via the diameter pipe. The centre-piece 16 includes a 21.4 mm diameter round tubing being 150 mm long and pressed into the 25 mm diameter round tube stem and being adapted to act as a telescopic extension between the centre-piece 16 and the ratchet system 14.

The ratchet system 14 includes a ratchet spool 28, strap 30 and strap loop 32 consisting of a 8 mm diameter round bar. The strap loop 32 guides the strap onto the ratchet spool 28. The ratchet system 14 includes a M8 Nylock nut and thread which is adapted to secure the strap 30 and ratchet spool 28 onto the M8 thread. The ratchet system 14 includes a 16 mm diameter pipe being 50 mm long and being adapted to serve as a second mounting onto the ratchet spool 28 with a M12 bolt and nut. The ratchet system 14 includes a top stem being 400 mm long and flattened at one end and bored at the other end. The top stem has a 25 mm×2 mm diameter. The ratchet system 14 includes a hook 34 consisting of a 10 mm round bar being welded close and electroplated yellow. The ratchet system 14 also includes a transparent plastic tube adapted to cover the hook 34 and protect the frame of the motorcycle or quad-bike from damage during handling and hoisting.

By using the lifting arrangement 10 average person is capable of lifting a heavy motorcycle once it has fallen down or to lift it to attend to repairs and also do this without straining one's back.

The lifting arrangement 10 is adapted to be folded away in a bag for compact storage.

The ratchet system 14 has been specially designed to fit onto the ratchet with loop and to avoid the belt or strap 30 from bundling.

The ratchet system 14 has been altered to press down instead of up when lifting.

The base plates or foot pieces 22 and 24 are adapted to grip in all terrains.

The lifting arrangement 10 is adapted to be used also as a bead-braker, i.e. removing a tyre from a rim.

The main function of the lifting arrangement 10 according to the invention is to provide a sturdy tool or apparatus without any small parts that can break and which will be able to assist an average person in picking up his or her motorcycle after the event of an unfortunate fall in order for him or her to be able to pick up the motorcycle from the ground without straining their back and thus enabling them to carry on with their trip.

The lifting arrangement 10 can also be used when legs are trapped under a motorcycle or quad-bike.

The lifting arrangement 10 can be used on the rear seat for easy and quick access should the above occur.

The lifting of the motorcycle or quad-bike for repairs and bead-braker function is secondary to the main and unique function of getting the bike off the ground easily and free of injury.

The lifting arrangement 10 according to the invention thus has the following characteristics:
(a) the ratchet system 14 operates vice versa and thus is operated by pushing down and not lifting up, since a person has more power pushing down;
(b) the ratchet system 14 includes a welded-on ratchet loop 32 to keep the strap 30 in line and prevents the strap 30 from sliding off the ratchet spool 28;
(c) the centre piece 16 connects the ratchet system 14 with the leg portions 18 and 20 and thereby provides stability and the possibility of lifting the motorcycle with one ratchet means (one leg portion is instable and more than two unnecessary;
(d) the hook 34 is covered with plastic to prevent damage to motorcycle and is adapted to hook the most centred position of the motorcycle and as low as possible in order to control the weight distribution;
(e) the hook 34 can connect to the crash bar or foot peg of the motorcycle; and
(f) due to the disconnecting component of the lifting arrangement 10 the components can be taken apart for compact storage.

1. A lifting arrangement, which includes
(a) a base supporting structure adapted to be placed firmly on supporting ground; and
(b) a ratchet system adapted to be supported by the base supporting structure, and being adapted to assist in lifting a motorcycle and/or quad-bike.

2. An arrangement as claimed in claim 1, in which the motorcycle and/or quad-bike is adapted to be lifted to enable repairs to be done to the motorcycle and/or quad-bike.

3. An arrangement as claimed in claim 1, in which the base supporting structure includes at least two legs portion for stability.

4. An arrangement as claimed in claim 3, in which the leg portions each include base plates and/or foot pieces.

5. An arrangement as claimed in claim 1, in which the ratchet is operated by means of downward pressure and/or force.

6. An arrangement as claimed in claim 1, which includes a centre-piece adapted to be telescopically connected to the base supporting structure and/or the ratchet system.
